(19) United States
(12) Patent Application Publication
(10) Pub. No.: US 2024/0346326 A1
(43) Pub. Date: Oct. 17, 2024

(54) LEARNING SYSTEM, LEARNING SERVER APPARATUS, PROCESSING APPARATUS, LEARNING METHOD, AND PROGRAM

(71) Applicant: NIPPON TELEGRAPH AND TELEPHONE CORPORATION, Tokyo (JP)

(72) Inventors: Iifan TYOU, Musashino-shi, Tokyo (JP); Takumi FUKAMI, Musashino-shi, Tokyo (JP)

(73) Assignee: NIPPON TELEGRAPH AND TELEPHONE CORPORATION, Tokyo (JP)

(21) Appl. No.: 18/291,238

(22) PCT Filed: Aug. 2, 2021
(86) PCT No.: PCT/JP2021/028592

§ 371 Date: Jan. 23, 2024

(51) Int. Cl. G06N 3/098

(52) U.S. Cl. CPC G06N 3/098

(57) ABSTRACT

Provided are a learning system and the like that significantly shorten a search time of NAS and enable machine learning in a practical time. The learning system includes a learning server apparatus and n processing apparatuses i. The processing apparatus i includes a score calculation unit that calculates a score sᵢᵣ when local data dᵢ is applied to each of A neural networks r. The learning server apparatus includes an aggregation unit that aggregates A neural networks using A×n scores sᵢᵣ and selects an optimal neural network. The first federated learning unit and the second federated learning units of the n processing apparatuses i cooperate to perform federated learning using the selected optimal neural network as a first global model. The score sᵢᵣ includes an index with which a neural network having an excellent learning effect can be searched for.

### TECHNICAL FIELD

The present invention relates to federated learning incorporating an automated machine learning (AutoML) method.

### BACKGROUND ART

Unlike neural network design in the related art, neural architecture search (NAS) is a method that automatically optimizes the architecture itself instead of defining the network structure (architecture) by humans, and is the basis of AutoML.

Non Patent Literature 1 is known as a method of incorporating NAS into federated learning as federated NAS (FedNAS). With this method, it is possible to implement AutoML in federated learning without looking at the structure of data.

### CITATION LIST

### Non Patent Literature

Non Patent Literature 1: Chaoyang He, Murali Annavaram, Salman Avestimehr, “FedNAS: Federated Deep Learning via Neural Architecture Search”, 2020 Conference on Computer Vision and Pattern Recognition, 2020

### SUMMARY OF INVENTION

### Technical Problem

However, the time required for NAS is long, and depending on use cases, it takes an impractical amount of time.

An object of the present invention is to provide a learning system, a learning server apparatus, a processing apparatus, a learning method, and a program that significantly shorten a search time of NAS and enable machine learning in a practical time.

### Solution to Problem

In order to solve the above problem, according to one aspect of the present invention, a learning system includes a learning server apparatus and n processing apparatuses i. When i=1, 2, . . . , n, and r=0, 1, . . . , A−1, the processing apparatuses i each include a second federated learning unit, and a score calculation unit configured to calculate a score sᵢᵣ when local data dᵢ is applied to each of A neural networks r. The learning server apparatus includes a first federated learning unit, and an aggregation unit configured to aggregate A neural networks using A×n scores, and select an optimal neural network. The first federated learning unit and the second federated learning units of the n processing apparatuses i cooperate to perform federated learning using the selected optimal neural network as a first global model. The score sᵢᵣ includes an index with which a neural network having an excellent learning effect can be searched for.

### Advantageous Effects of Invention

According to the present invention, there is an effect of significantly shortening the search time of NAS and enabling machine learning in a practical time.

### BRIEF DESCRIPTION OF DRAWINGS

FIG. 1 is a diagram illustrating a configuration example of a learning system according to a first embodiment.

FIG. 2 is a functional block diagram of a learning server apparatus according to the first embodiment.

FIG. 3 is a functional block diagram of a processing apparatus according to the first embodiment.

FIG. 4 is a diagram illustrating a processing sequence of the learning system.

FIG. 5 is a diagram illustrating an example of a processing flow of an aggregation unit.

FIG. 6 is a diagram illustrating an example of a processing flow of the aggregation unit.

FIG. 7 is a diagram illustrating a configuration example of a computer to which the present method is applied.

### DESCRIPTION OF EMBODIMENTS

An embodiment of the present invention will be described below. In the drawings to be used in the following description, components having the same functions or steps for performing the same process will be denoted by the same reference numerals, and redundant description will be omitted. In the following description, processing to be performed for each element of a vector or a matrix is applied to all elements of the vector or the matrix, unless otherwise specified.

### <Points of First Embodiment>

As research on NAS, a NAS without training method has been proposed which focuses on the small correlation between weights in a neural network and searches for a useful neural architecture without performing time-consuming training (see Reference Literature 1).

(Reference Literature 1) Joseph Mellor, Jack Turner, Amos Storkey, Elliot J. Crowley, “Neural Architecture Search without Training”, 2021 International Conference on Machine Learning, 2021

In the present embodiment, the learning is speeded up by combining the existing federated learning method and the NAS without training method and adding ingenuity in implementation.

Existing method 1: Federated learning method: Data learning is performed on a data holder terminal, and a loop of collecting→aggregating→distributing→relearning learned models is rotated to generate a learning model with a high accuracy based on data of a plurality of data holders.

Existing method 2: When a randomly generated neural network is applied to data, if the correlation between weights in the network is small, it is considered that the learning effect is high. Searching for such a neural architecture can be performed in an overwhelmingly shorter time compared with NAS that performs learning for each existing architecture.

Proposed method: A method for applying Existing method 2 to federated learning to optimize processing is proposed. This makes it possible to significantly speed up NAS in federated learning and improve the efficiency of an output network (perform highly accurate learning and prediction in a small network).

The proposed method makes it possible to significantly speed up neural architecture search in federated learning and improve the efficiency of an output network (perform highly accurate learning and prediction in a small network).

Specifically,

(1) In order to significantly shorten the search time of NAS and enable machine learning in a practical time, learning for each search neural architecture, which is particularly time-consuming in NAS, is omitted by the NAS without training method.

(2) In order to make the learning accuracy practicable without greatly degrading the learning accuracy from the result of the optimal neural architecture search, it is possible to perform highly accurate learning by selectively using the output of NAS without training.

More specifically,

(A) The server controls the architecture search range in the initial phase (processing for corresponding to (1) described above).

(B) Each worker evaluates a correlation score of the weight when the local data is applied to the given architecture (processing for corresponding to (1) described above).

(C) Each worker transmits the correlation score for each architecture to the server (processing for corresponding to (1) described above).

(D) The server performs aggregation based on the correlation score and selects an optimal architecture (processing for corresponding to (2) described above).

(E) Each worker performs learning based on the optimal architecture (processing for corresponding to (1) described above).

### <Features of Present Embodiment>

By executing NAS without training as the initial phase of the federated learning, the operation time of NAS is significantly reduced.

The score evaluation of NAS without training can be operated with a load of about one learning epoch.

Since a network is narrowed down while learning for a large number of networks in a simple NAS, for example, in a case where an optimal network is searched for from 1000 types of networks, learning is performed up to 1000 times, but even if the score evaluation time is added, the learning time can be shortened to 2/1000 or less.

It is known that a plurality of neural networks having a small correlation with which the learning accuracy can be improved by NAS without training are generally found. By selecting a neural network having a small structure in aggregation from these neural networks, performance tuning (speeding up) compatible with federated learning is realized.

In general, the learning parameters can be reduced and the learning time can be shortened.

In federated learning that transfers a model over a network, a communication time and an aggregation operation amount in an aggregation server can also be reduced.

In addition to independent and identically distributed (IID) in which the worker uniformly holds similar data, a non-IID in which the amount and type of data are biased for each worker occurs in the federated learning. NAS without training for calculating a correlation score by referring to data may not be used as it is. Therefore, NAS without training can be used for non-IID data by adding a confirmation phase of the selected neural network.

At that time, verification of the neural network selected in the “selected network confirmation phase” is performed to enable neural architecture selection assuming non-IID.

Hereinafter, a learning system that implements the above-described processing will be described.

### <Learning System According to First Embodiment>

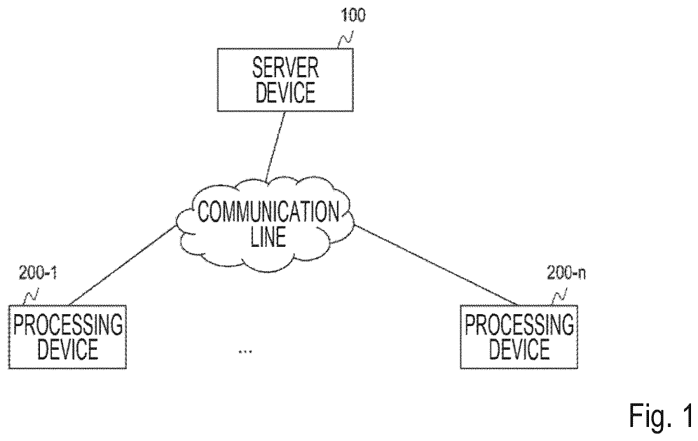

FIG. 1 is a diagram illustrating a configuration example of a learning system according to a first embodiment. The learning system includes a learning server apparatus 100 and n processing apparatuses 200-i, and the learning server apparatus 100 and the processing apparatuses 200-i are communicable via a communication line. Here, i=1, 2, . . . , n. The learning server apparatus 100 corresponds to the above-described server, and the processing apparatus 200-i corresponds to the above-described worker.

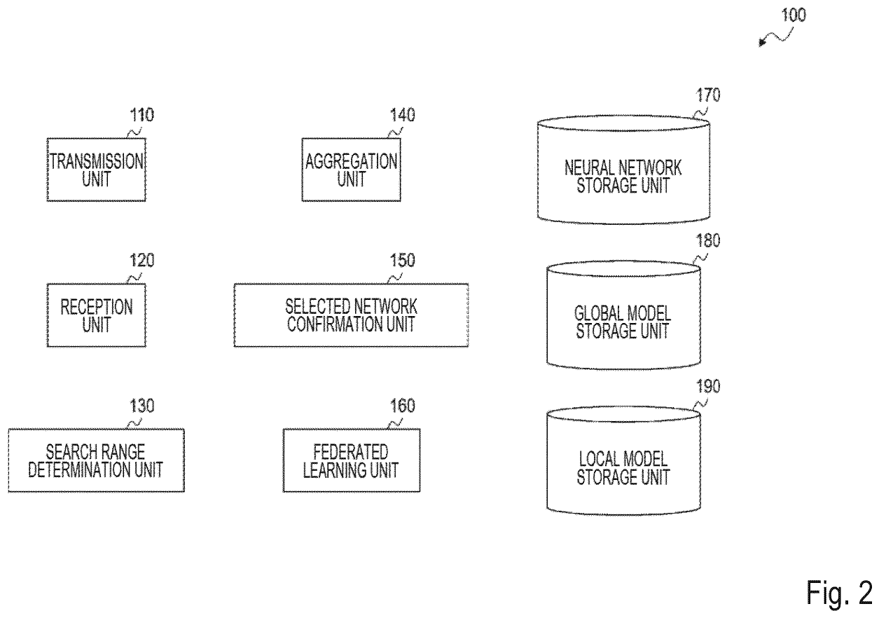

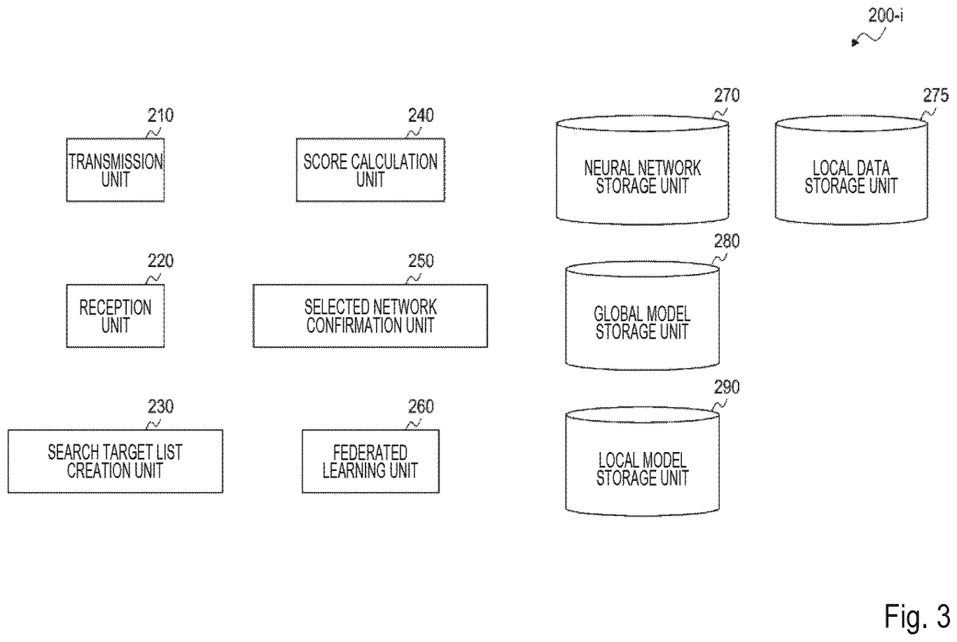

FIGS. 2 and 3 are functional block diagrams of the learning server apparatus 100 and the processing apparatus 200-i according to the first embodiment, respectively.

The learning server apparatus 100 includes a transmission unit 110, a reception unit 120, a search range determination unit 130, an aggregation unit 140, a selected network confirmation unit 150, a federated learning unit 160, a neural network storage unit 170, a global model storage unit 180, and a local model storage unit 190.

The processing apparatus 200-i includes a transmission unit 210, a reception unit 220, a search target list creation unit 230, a score calculation unit 240, a selected network confirmation unit 250, a federated learning unit 260, a neural network storage unit 270, a local data storage unit 275, a global model storage unit 280, and a local model storage unit 290.

The learning server apparatus 100 and the processing apparatus 200-i are special apparatuses configured by loading a special program into a known or dedicated computer including a central processing unit (CPU), a main memory (random access memory (RAM)), and the like, for example. The learning server apparatus 100 and the processing apparatus 200-i perform each process under the control of the central processing unit, for example. Data input to the learning server apparatus 100 and the processing apparatus 200-i and data obtained in each process are stored in the main memory, for example. The data stored in the main memory is read into the central processing unit, and is used for other processes as necessary. At least one of the processing units in the learning server apparatus 100 and the processing apparatus 200-i may be formed with hardware such as an integrated circuit. Each storage unit included in the learning server apparatus 100 and the processing apparatus 200-i can be formed with the main memory such as a random access memory (RAM) or middleware such as a relational database or a key-value store, for example. However, each storage unit is not necessarily included in the learning server apparatus 100 and the processing apparatus 200-i. Each storage unit may be formed with an auxiliary memory including a semiconductor memory element such as a hard disk, an optical disc, or a flash memory, and be provided outside the learning server apparatus 100 and the processing apparatus 200-i.

A processing sequence of the learning system will be described below.

### <Processing Sequence>

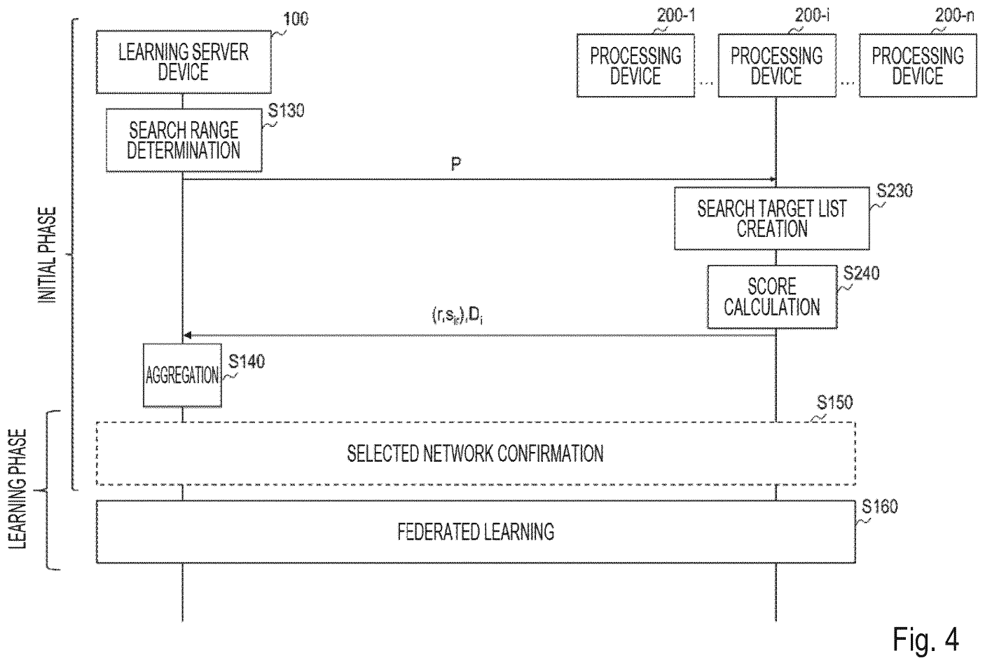

FIG. 4 illustrates a processing sequence of the learning system.

### <Search Range Determination Process S130>

The search range determination unit 130 of the learning server apparatus 100 determines a NAS search range (S130), and transmits information indicating the NAS search range (hereinafter also referred to as search range information P) to each of the n processing apparatuses 200-i via the transmission unit 110. Note that the search range information P is information common to the n processing apparatuses 200-i.

For example, the neural network storage unit 170 stores K neural networks and indexes k thereof. Note that k=1, 2, . . . , K. The K neural networks are randomly generated similarly to Reference Literature 1, for example.

The search range determination unit 130 determines A neural networks among the K neural networks stored in the neural network storage unit 170 as the NAS search range. K and A are any integer of 2 or more, and satisfy K≥A. For example, the search range determination unit 130 determines a combination of a random number seed indicating a start point and A indicating a range as the search range information P. For example, K=10,000 and A=1000. The neural network storage unit 270 stores the same information as that stored in the neural network storage unit 170. That is, the neural network storage unit 270 stores K neural networks and indexes k thereof.

### <Search Target List Creation Process S230>

The search target list creation unit 230 of the processing apparatus 200-i receives the search range information P via the reception unit 220, and creates a NAS search target network list from the information stored in the neural network storage unit 270 based on the search range information P (S230). For example, assuming that the random number seed is s, the search target list creation unit 230 creates a list of A neural networks corresponding to k=s, s+1, . . . , s+A−1.

### <Score Calculation Process S240>

The score calculation unit 240 of the processing apparatus 200-i extracts the local data dᵢ stored in the local data storage unit 275. Note that the local data dᵢ is different for each processing apparatus 200-i, and is data that is an input of the neural network. The score calculation unit 240 calculates a correlation score sᵢᵣ of the weight when the local data dᵢ is applied to each of the A neural networks included in the NAS search target network list (S240). Note that, as in the related art, if the correlation score of the weight is small, it is considered that the learning effect is high. i is an index indicating a processing apparatus, r is an index indicating a neural network, and r=0, 1, . . . , A−1. Therefore, the correlation score sᵢᵣ indicates the correlation score of the weight of the neural network r in the processing apparatus 200-i. The score calculation unit 240 transmits the combination of the index r of the neural network and the correlation score sᵢᵣ thereof and the number Dᵢ of pieces of data of the local data dᵢ to the learning server apparatus 100 via the transmission unit 210.

### <Aggregation Process S140>

The aggregation unit 140 of the learning server apparatus 100 receives A combinations of indexes r and correlation scores sᵢᵣ and one number Dᵢ of pieces of data from one processing apparatus 200-i via the reception unit 120. Since the aggregation unit 140 receives data from the n processing apparatuses 200-i, a total of A×n combinations of indexes r and correlation scores sᵢᵣ and n number Dᵢ of pieces of data are received.

The aggregation unit 140 aggregates A neural networks by using A×n correlation scores sᵢᵣ and n number Dᵢ of pieces of data (S140), and selects an optimal neural network. The optimal neural network here is a neural network that enables highly accurate learning.

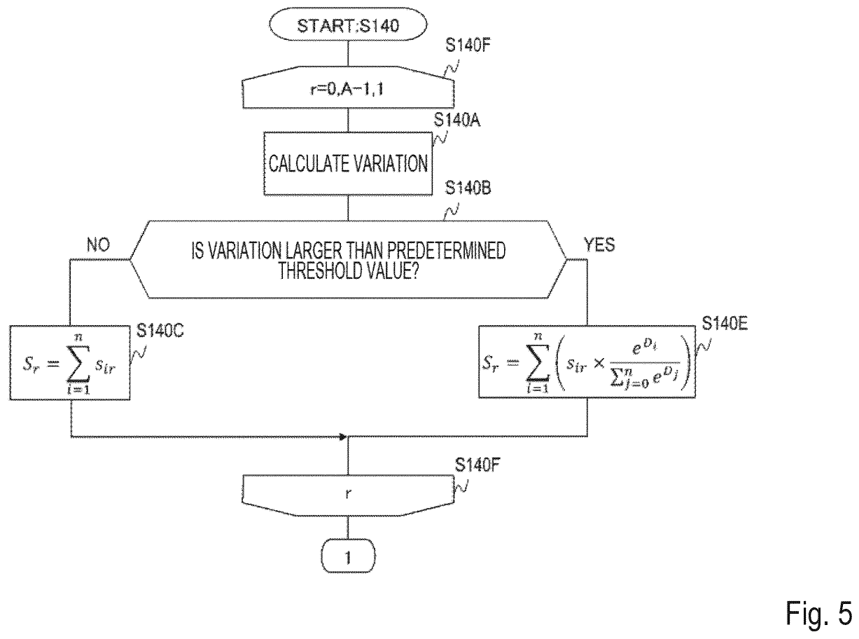

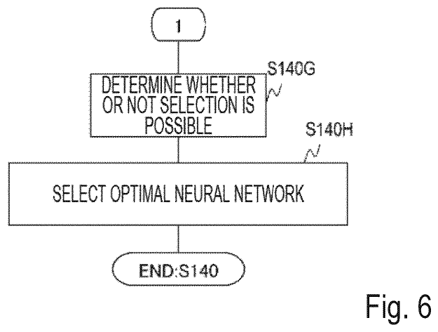

FIGS. 5 and 6 illustrate an example of a processing flow of the aggregation unit 140.

The aggregation unit 140 calculates a variation in the correlation score sᵢᵣ of each processing apparatus 200-i for each neural network (S140A), and determines whether or not the variation is larger than a predetermined threshold value (S140B).

In a case where the variation is equal to or less than the predetermined threshold value, the aggregation unit 140 determines that general-purpose network learning is possible, and calculates a score for each neural network by a formula designated by the user (S140C). In a case where the total score of all the terminals is used as an example of the formula, the following formula is obtained.

$$\begin{matrix}[ Math . 1 ] & \\ {S}_{r} = {\sum }_{i = 1}^{n} {s}_{ir} & ( 1 )\end{matrix}$$

In a case where the variation is larger than the predetermined threshold value, there is a high likelihood that a difference will occur in learning of the non-IID data, and thus, in consideration of the influence of the number Dᵢ of pieces of data, the aggregation unit 140 calculates a score for each neural network by a formula in consideration of the influence of the number of pieces of data designated by the user (S140E). As an example, the following formula is assumed.

$$\begin{matrix}[ Math . 2 ] & \\ {S}_{r} = {\sum }_{i = 1}^{n} ( {s}_{ir} \times \frac{{e}^{{D}_{i}}}{{\sum }_{j = 0}^{n} {e}^{{D}_{j}}} ) & ( 2 )\end{matrix}$$

Here, e is the base of natural logarithms.

In a case where both Formula (1) and Formula (2) appear here, the magnitude of the value is adjusted according to a user definition.

The above-described processes S140A to S140E are performed on all the neural networks (S140F).

The aggregation unit 140 determines whether or not an optimal neural network can be selected from A pieces of Sᵣ according to the user setting (S140G). In the process in the case of determining whether or not selection is possible from the similarity of scores=the magnitude of the difference as the user setting, there is a method of extracting P scores Sₘᵢₙ, Sₘᵢₙ₊₁, . . . , Sₘᵢₙ₊ₚ to be compared, which are preset in ascending order from the minimum score Sₘᵢₙ among the A pieces of Sᵣ, and calculating the following formula from the difference from the minimum score Sₘᵢₙ.

$$\begin{matrix}[ Math . 3 ] & \\ dif = {\sum }_{i = 1}^{P} ( {s}_{min + i} - {s}_{min} ) & \end{matrix}$$

In a case where the similarity is low (=the score difference dif is equal to or larger than the user-specified value), it is assumed that the score comparison can be successfully performed, and the network having the score Sₘᵢₙ is selected as the optimal neural network (S140H). In a case where the similarity is high (=the score difference dif is equal to or larger than the user-specified value), it is assumed that the score comparison is difficult. In a case where the score comparison is difficult, whether the selection is performed by adding an additional condition to the selection as the optimal neural network, or whether the selection is continued to the following possibility selection process by determining that there is no optimal neural network depends on the user setting. As an example of the additional condition, in order to select a neural network having a small size with a short learning time, a case of selecting a neural network having a minimum network size from Sₘᵢₙ, Sₘᵢₙ₊₁, . . . , Sₘᵢₙ₊ₚ as an optimal neural network, or a case of selecting a neural network having a long learning time but a maximum network size with high expression capability as an optimal neural network is considered.

### (Possibility Selection Process)

In a case where an optimal neural network cannot be selected in the aggregation unit 140, the aggregation unit 140 selects Q optimal neural network possibilities, and outputs indexes of the selected Q possibilities to the selected network confirmation unit 150. Q is any integer of 2 or more, and satisfies Q<A and Q<n. Note that the case where an optimal neural network cannot be selected is, for example, (A) a case where a bias in data type is assumed, (B) a case where a variation in the correlation score sᵢᵣ for each processing apparatus is large and the number of classifications is large, and it is difficult to narrow down only by the number Dᵢ of pieces of data in the processing apparatus 200-i, (C) a case where it is not known whether consideration of the number of pieces of data is appropriate with the non-IID, (D) a case where there are two or more neural networks in which the difference obtained in S140G is smaller than a predetermined threshold value and the network size is minimum, and the like. For example, the aggregation unit 140 selects Q neural networks in which the difference obtained in S140G is smaller than a predetermined threshold value and the network size is smaller than the predetermined threshold value as optimal neural network possibilities.

### <Selected Network Confirmation Process S150>

Since a selected network confirmation process S150 in the selected network confirmation unit 150 of the learning server apparatus 100 is executed only in a case where an optimal neural network cannot be selected, it is indicated by a broken line in FIG. 4. The selected network confirmation unit 150 of the learning server apparatus 100 divides the n processing apparatuses 200-i into Q groups. Each group includes (n/Q) processing apparatuses 200-i. The selected network confirmation unit 150 receives the indexes of the Q possibilities, and transmits the indexes of the Q possibilities to the processing apparatuses 200-i belonging to the Q groups, respectively, via the transmission unit 110. The selected network confirmation unit 150 extracts Q neural networks corresponding to the indexes of the Q possibilities from the neural network storage unit 170, and performs short-term normal federated learning in cooperation with the selected network confirmation units 250 of the processing apparatuses 200-i belonging to the Q groups using each of the Q neural networks as a first global model. As the normal federated learning, for example, the federated learning of Non Patent Literature 1 and the like can be considered, but other federated learning methods may be used. The selected network confirmation unit 150 and the selected network confirmation units 250 of the (n/Q) processing apparatuses 200-i belonging to one group cooperate to perform the federated learning using one neural network as the first global model and perform the federated learning using a total of Q neural networks as the first global model. Note that the selected or updated global model used in the federated learning is stored in the global model storage unit 180, and the n local models updated by each processing apparatus 200-i, which are used in the federated learning, are stored in the local model storage unit 190.

The selected network confirmation unit 250 of the processing apparatus 200-i receives the index of the possibility neural network via the reception unit 220, extracts the neural network corresponding to the index from the neural network storage unit 270, and performs the short-term normal federated learning in cooperation with the selected network confirmation unit 150 of the learning server apparatus 100 using the extracted neural network as the global model. Note that the global model selected or updated by the selected network confirmation unit 150 of the learning server apparatus 100, which is used in the federated learning, is stored in the global model storage unit 280, and one local model updated by the processing apparatus 200-i, which is used in the federated learning, is stored in the local model storage unit 290.

The selected network confirmation unit 150 of the learning server apparatus 100 compares the accuracies of the Q optimal neural network possibilities after the short-term normal federated learning, selects a neural network with the highest accuracy as the optimal neural network (S150), and outputs an index thereof to the aggregation unit 140. By providing the selected network confirmation process S150, the likelihood that an optimal neural network can be selected increases. Since the (n/Q) processing apparatuses 200-i corresponding to the optimal neural network can correctly perform learning also in the selected network confirmation process S150, the learned model can be used. Here, the learning results of selected network confirmation process S160 of the remaining (n-n/Q) processing apparatuses 200-i are discarded.

The aggregation unit 140 of the learning server apparatus 100 outputs the index of the optimal neural network to the federated learning unit 160.

### <Federated Learning Process S160>

The federated learning unit 160 receives the index of the optimal neural network, and performs normal federated learning in cooperation with the federated learning unit 260 of the processing apparatus 200-i using the neural network corresponding to the index as the first global model (S160).

### <Effects>

With the above configuration, it is possible to significantly shorten the search time of NAS and enable machine learning in a practical time. In addition, the accuracy of learning is made practicable without greatly degrading from the result of the optimal neural architecture search.

### Modification Example 1

In the first embodiment, the correlation score sᵢᵣ is used to search for a neural network having an excellent learning effect, but other indexes may be used as long as the indexes can search for a neural network having an excellent learning effect.

### Modification Example 2

In the first embodiment, in the process S140E, the score is calculated in consideration of the influence of the number Dᵢ of pieces of data, but the score may be calculated by an aggregation operation defined by the user such as the following methods (1) to (6).

(1) The score Sᵣ is calculated by the following formula in consideration of the average score for each piece of data.

$$\begin{matrix}[ Math . 4 ] & \\ {S}_{r} = {\sum }_{i = 1}^{n} \frac{{S}_{ir}}{{D}_{i}} & ( 2 - 1 )\end{matrix}$$

(2) The score Sᵣ is calculated by the following formula in consideration of the median score for each piece of data.

$$\begin{matrix}[ Math . 5 ] & \\ {S}_{r} = median ( \frac{{S}_{ir}}{{D}_{i}} ) & ( 2 - 2 )\end{matrix}$$

Here, median( ) is a function that returns a median value.

(3) The score Sᵣ is calculated by the following formula in consideration of the overall average score.

$$\begin{matrix}[ Math . 6 ] & \\ {S}_{r} = median ( {s}_{ir} ) & ( 2 - 3 )\end{matrix}$$

(4) The score Sᵣ is calculated by the following formula in consideration of the mode score for each piece of data.

$$\begin{matrix}[ Math . 7 ] & \\ {S}_{r} = mode ( \frac{{S}_{ir}}{{D}_{i}} ) & ( 2 - 4 )\end{matrix}$$

Here, mode( ) is a function that returns a mode value.

(5) The score Sᵣ is calculated by the following formula in consideration of the overall mode score.

$$\begin{matrix}[ Math . 8 ] & \\ {S}_{r} = mode ( {s}_{ir} ) & ( 2 - 5 )\end{matrix}$$

(6) The final score Sᵣ is calculated using at least two of the scores Sᵣ of (1) to (5) described above and the score Sᵣ obtained by Formula (2) of the first embodiment. For example, the score is calculated by the following formula.

$$\begin{matrix}[ Math . 9 ] & \\ & ( 2 - 6 )\end{matrix}$$

$${S}_{r} = medium ( {\sum }_{i = 1}^{n} \frac{{S}_{ir}}{{D}_{i}} , {\sum }_{i = 1}^{n} {S}_{ir} , median ( \frac{{S}_{ir}}{{D}_{i}} ) , median ( {S}_{ir} ) , mode ( \frac{\text{?}}{{D}_{i}} ) , mode ( {S}_{ir} ) , {\sum }_{i = 1}^{n} ( {S}_{ir} \times \frac{{e}^{{D}_{i}}}{{\sum }_{j = 0}^{n} {e}^{{D}_{i}}} ) )$$

$$\text{?} \text{indicates text missing or illegible when filed}$$

Note that the above calculation is only statistics for A*n (float) numbers, and the calculation load in the learning server apparatus 100 is not high.

In the process S140E, not only the score Sᵣ described above but also other scores may be calculated as long as the score enables searching for a neural network having an excellent learning effect.

### Modification Example 3

In the first embodiment, the method of calculating the score Sᵣ is changed for each neural network on the basis of the magnitude relationship between the variation and the predetermined threshold value, but the score Sᵣ may be calculated by Formulas (1) and (2) for all the neural networks. That is, A scores Sᵣ are obtained by Formula (1), and A scores Sᵣ are obtained by Formula (2). Then, as in the first embodiment, the difference calculation S140G is performed using the magnitude relationship between the variation and the predetermined threshold value. For example, in a case where the variation is larger than the predetermined threshold value, the score Sᵣ obtained by Formula (1) is used, and in a case where the variation is equal to or less than the predetermined threshold value, the score Sᵣ obtained by Formula (2) is used to calculate the difference.

### Modification Example 4

In the first embodiment, the aggregation unit 140 calculates the variation in the correlation score sᵢᵣ of each processing apparatus 200-i for each neural network (S140A), and determines whether or not the variation is larger than the predetermined threshold value (S140B). However, (i) in a case where it is known in advance that the variation is small, S140A and S140B may be omitted, and the score Sᵣ may be calculated by Formula (1). In addition, (ii) in a case where it is known in advance that the variation is large, S140A and S140B may be omitted, and the score Sᵣ may be calculated by Formula (2). Also, (iii) in a case where the variation is not considered, S140A and S140B may be omitted, and the score Sᵣ may be calculated by Formula (1).

### <Other Modification Examples>

The present invention is not limited to the foregoing embodiments and modification examples. For example, various kinds of processing described above may be executed not only in time series in accordance with the description but also in parallel or individually in accordance with processing abilities of the apparatuses that execute the processes or as necessary. Further, modifications can be made as needed within the gist of the present invention.

### <Program and Recording Medium>

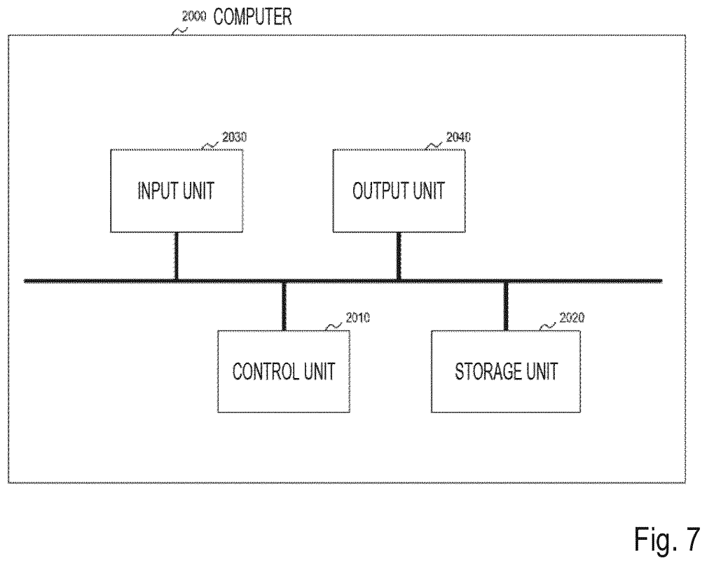

Various kinds of processing described above can be carried out by causing a storage unit 2020 of a computer illustrated in FIG. 7 to load the program for executing each step of the method described above and causing a control unit 2010, an input unit 2030, an output unit 2040, and the like to operate.

The program describing the processing content may be recorded on a computer-readable recording medium. The computer-readable recording medium may be, for example, any recording medium such as a magnetic recording apparatus, an optical disc, a magneto-optical recording medium, or a semiconductor memory.

Distribution of the program is performed by, for example, selling, transferring, or renting a portable recording medium such as a DVD or a CD-ROM on which the program is recorded. The program may be stored in a storage apparatus of a server computer, and the program may be distributed by transferring the program from the server computer to another computer via a network.

For example, the computer that executes such a program first temporarily stores the program recorded in the portable recording medium or the program transferred from the server computer in the storage apparatus of the own computer. Then, when executing processing, the computer reads the program stored in the recording medium of the own computer and executes processing according to the read program. As another mode of executing the program, the computer may directly read the program from the portable recording medium and execute processing according to the program, or, every time when the program is transferred from the server computer to the computer, the computer may sequentially execute processing according to the received program. In addition, the above-described processing may be executed by a so-called application service provider (ASP) type service that implements a processing function only by an execution instruction and result acquisition without transferring the program from the server computer to the computer. The program in the present embodiment includes information used for processing by an electronic computer and equivalent to the program (data or the like that is not direct command to the computer but has property that defines the processing of the computer).

Although the present apparatus is configured by executing a predetermined program on a computer in the present embodiment, at least part of the processing content may be realized by hardware.

1. A learning system comprising:
a learning server apparatus; and
n processing apparatuses i,
wherein, when i=1, 2, . . . , n, and r=0, 1, . . . , A−1,
the processing apparatuses i each include:
second processing circuitry configured to:
execute a second federated learning processing; and
execute a score calculation processing in which the second processing circuitry calculates a score sᵢᵣ when local data dᵢ is applied to each of A neural networks r,
the learning server apparatus includes:
first processing circuitry configured to:
execute a first federated learning processing; and
execute an aggregation processing in which the first processing circuitry aggregates A neural networks using A×n scores sᵢᵣ, and selects an optimal neural network,
in the first federated learning processing and the second federated learning processes, the first processing circuitry and the second processing circuitries of the n processing apparatuses i cooperate to perform federated learning using the selected optimal neural network as a first global model, and
the score sᵢᵣ includes an index with which a neural network having an excellent learning effect can be searched for.

2. The learning system according to claim 1, wherein
the score sᵢᵣ is a correlation score of a weight when the local data dᵢ is applied to the neural network r, and
the aggregation processing in which the first processing circuitry calculates a variation of the score sᵢᵣ for each neural network r, calculates a score Sᵣ for each neural network r in consideration of a number of pieces of data of the local data dᵢ in a case where the variation is larger than a predetermined threshold value, and calculates the score Sᵣ for each neural network r without considering the number of pieces of data of the local data dᵢ in a case where the variation is equal to or smaller than the predetermined threshold value.

3. The learning system according to claim 1, wherein
in the aggregation processing the first processing circuitry selects Q optimal neural network possibilities in a case where an optimal neural network cannot be selected, and
the first processing circuitry divides the n processing apparatuses i into Q groups, performs federated learning in cooperation with a second processing circuitry of a processing apparatus belonging to each group using the Q optimal neural network possibilities as a first global model, compares accuracies of the Q optimal neural network possibilities after the federated learning, and selects an optimal neural network with the highest accuracy as the optimal neural network.

4. A learning server apparatus of the learning system according to claim 1.

5. A processing apparatus of the learning system according to claim 1.

6. A learning method using a learning server apparatus that includes first processing circuitry and n processing apparatuses i that include second processing circuitry, the learning method comprising:
when i=1, 2 . . . , n, and r=0, 1, . . . , A−1,
a score calculation step of calculating, by the second processing circuitry of the processing apparatus i, a score sᵢᵣ when local data dᵢ is applied to each of A neural networks r;
an aggregation step of aggregating, by the first processing circuitry of the learning server apparatus, A neural networks using A×n scores sᵢᵣ, and selecting an optimal neural network; and
a federated learning step of cooperating, by the first processing circuitry of the learning server apparatus and the second processing circuitries of the n processing apparatuses i, to perform federated learning using the selected optimal neural network as a first global model,
wherein the score sᵢᵣ includes an index with which a neural network having an excellent learning effect can be searched for.

7. A non-transitory computer-readable recording medium having recorded thereon a program for causing a computer to function as the learning server apparatus according to claim 4.

8. A non-transitory computer-readable recording medium having recorded thereon a program for causing a computer to function as the processing apparatus according to claim 5.
